(19) United States
(12) Patent Application Publication
(10) Pub. No.: US 2020/0303136 A1
(43) Pub. Date: Sep. 24, 2020

(54) ELECTROCHEMICAL STORAGE DEVICES AND MATERIALS DERIVED FROM NATURAL PRECURSORS

(71) Applicant: Sparkle Power LLC, Rochester, NY (US)

(72) Inventors: Ziqiang Xu, Chengdu (CN); Mengqiang Wu, Chengdu (CN); David Mitlin, Lakeway, TX (US)

(21) Appl. No.: 16/822,514

(22) Filed: Mar. 18, 2020

Related U.S. Application Data
(60) Provisional application No. 62/819,881, filed on Mar. 18, 2019.

(51) Int. Cl. H01G 11/34; H01G 11/26; H01G 11/54

(52) U.S. Cl. CPC H01G 11/34; H01G 11/54; H01G 11/26

(57) ABSTRACT

An electrochemical energy storage device, including a potassium ion capacitor. One embodiment is a device having an asymmetric architecture based on bulk K ion insertion, partially ordered, dense hard carbon anode (HC) opposing heteroatom-rich K ion adsorption, high surface area, mesoporous cathode (AC). Another embodiment is a double hybridized device employing a symmetric configuration AC-AC with a carbonate-based high voltage electrolyte and multifunctional high surface area K ion adsorption electrodes. The electrode carbons are derived from natural precursors including hemp, cannabis, mulberry branches, and/or silkworm excrement.

### CROSS-REFERENCE TO RELATED APPLICATIONS

The instant application claims priority to co-pending U.S. Provisional Application No. 62/819,881, filed on Mar. 18, 2019, and entitled “Hybrid Potassium-Based Energy Storage Devices and Materials from Hemp or Cannabis Precursors”. The entirety of the aforementioned provisional application is incorporated by reference in its entirety.

### FIELD OF THE INVENTION

The present invention relates to electrochemical storage devices and improvements related thereto, and more particularly to a hybrid ion capacitor with an improved electrode.

### BACKGROUND OF THE INVENTION

There are primarily two types of commercial devices for electrochemical energy storage, batteries and supercapacitors (also referred to as electrochemical capacitors and ultracapacitors). Batteries deliver high energy density, while supercapacitors offer high power and high cyclability. An emerging target for advanced electrical energy storage devices is to deliver both high energy and high power in a single system. For this reason battery-supercapacitor hybrid devices are attracting increasing scientific attention.

A hybrid ion capacitor (HIC) is a relatively new device that is intermediate in energy between batteries and supercapacitors, while ideally offering supercapacitor-like power and cyclability. One example of a potential end-use of HICs is in regenerative braking applications, especially for subway trains, where relatively high energy and very fast charge capability are essential.

Although one may view HICs to represent the extreme end of high-power ion batteries, the two voltage profiles are fundamentally different, with the former not containing plateaus. The voltage versus capacity profile of HICs is closer to that of a classical supercapacitor, i.e. nearly triangular without obvious plateaus, e.g. Importantly HICs are fundamentally distinct from EDLC supercapacitors, as in the former charge storage includes bulk mechanisms. These bulk ion storage mechanisms are not fully understood, except that it would be impossible to achieve 200-60 Wh/kg energies without them.

The original embodiment of the HIC operated in lithium (Li) ions. The devices employed a standard intercalation battery-graphite anode, combining it with an activated carbon cathode that stored charge by EDLC. However, since the electrodes are in series, the device power output was limited by Li intercalation into the micron-scale graphite particulates. More effective recent versions design the structure of both electrodes to operate at high rates, markedly improving the overall device power characteristics. Such architectures may be termed “intrinsically parallel”, providing enough rate capability in the anode to catch up to the performance of the cathode.

Sodium (Na) ion-based energy storage is attracting interest as a potentially lower cost alternative to Li ion systems, with readily available and geographically democratic reserves of the precursor. For this reason, materials for sodium ion battery (NIB, SIB) and sodium ion capacitor (NIC, SIC) anodes have received substantial attention. Potassium (K) based energy storage is much newer than either Na or Li devices, and is beginning to attract attention as well.

While Li is present in the earth's crust at 20 ppm levels, Na and K are much more abundant at 23 000 ppm and 17 000 ppm, respectively. Neither K nor Na reacts with aluminum, giving another price advantage over Li systems that require a copper current collector for the anode.

What is needed in the art, in one aspect, is a device that combines the advantages of supercapacitors and batteries, while taking advantage of lower cost alternatives to Li ion systems. The device described herein is believed to address at least this need, and others.

### BRIEF DESCRIPTION OF THE DRAWINGS

FIG. 1 illustrates a front view of an electrochemical energy storage device according to an embodiment disclosed herein.

FIGS. 2(A) and (B) are SEM micrograph of activated carbon “AC” and hard carbon “HC”. FIG. 2(C) is TEM HAADF image and EDXS analytical maps of C, N and O for AC. FIGS. 2(D) and (E) are HRTEM micrograph highlighting the disordered structure of AC and HC, respectively. FIG. 2(F) is X-ray diffraction patterns of AC and HC, highlighting their amorphous structure.

FIG. 3(A) is Raman spectra of AC and HC. FIG. 3(B) Nitrogen adsorption isotherms of AC and HC. FIG. 3(C) is pore-size distribution of AC and HC. FIG. 3(D) is X-ray Photoelectron Spectroscopy (XPS) C, N and O spectra of AC.

FIG. 4(A)-(I) are graphs of half-cell electrochemical performance of HC versus K/K+ and Na/Na+. FIGS. 4(A)-(B) Cyclic voltammetry CV tested at 0.1 mV/s, for K/K+ and Na/Na+. FIGS. 4(C)-(D) Multi-rate CV curves versus K/K+ and Na/Na+, respectively. (E) The overpotential values of the potassium and sodium systems at various scan rates. (F) The variation of normalized capacity as a function of the inverse square root of the scan rate. (G) b-value determination based on logarithmic peak currents versus scan rate. (H)-(I) Electrochemical impedance spectroscopy EIS for K/Ka⁺ and Na/Na.

FIGS. 5(A)-(E) are graphs of half-cell electrochemical performance of HC versus K/K+ and Na/Na+. FIGS. 5(A)-(B) Galvanostatic charge-discharge curves at 0.03 A/g for K/K+ and Na/Na+. FIGS. 5(C)-(D) Rate performance capacity retention comparison, showing the absolute capacity and the capacity retention fraction as a function of current density. FIG. 5(E) Cycling capacity retention comparison.

FIGS. 6(A)-(F) are performance comparisons of Symmetric Hybrid Ion Capacitor (S-HIC) device based on K+ and Na+. FIGS. 6(A)-(B) Charge-discharge curves at different current densities. FIG. 6(C) Specific capacitance of PSNC versus current density. FIG. 6(D) Extended cycling performance, tested at 0.8 A/g. FIG. 6(E) Ragone plot comparison of S-HIC-K versus prior HIC-K literature. FIG. 6(F) Ragone plot comparison of S-HIC-Na.

FIGS. 7(A)-(F) are performance comparisons of an Asymmetric Hybrid Ion Capacitor (A-HIC) device based on K+ and Na+. (A) CV curves of A-HIC-K recorded at different scan rates. (B) Galvanstatic curves of A-HIC-K at a current densities of 0.4 A/g. (C)-(D) CV and Galvanostatic data for A-HIC-Na. (E) Ragone Plot comparison of A-HIC-K and A-HIC-Na. (F) Extended cycling performance of A-HIC-K and A-HIC-Na.

### SUMMARY OF THE INVENTION

One embodiment is directed to a potassium-based electrochemical storage device, in particular, a potassium ion capacitor, comprising a partially ordered dense hard carbon anode having bulk potassium ion insertion; and a mesoporous activated carbon cathode having heteroatom-rich potassium ion adsorption and a high surface area. In one embodiment, the carbon of the dense hard carbon anode is derived from a natural precursor, which is, in one embodiment, at least one of hemp, cannabis, mulberry branches and silkworm excrement. In one embodiment, the carbon of the mesoporous activated carbon cathode is derived from a natural precursor, which is, in one embodiment, at least one of hemp, cannabis, mulberry branches and silkworm excrement.

A further embodiment is directed to an electrode for an electrochemical energy storage device, in particular, a potassium ion capacitor. The electrode comprising a carbon derived from a natural precursor, the natural precursor selected from the group consisting of hemp, cannabis, mulberry branches, silkworm excrement, and combinations thereof. In one embodiment of the electrode, the carbon is derived from hemp. In another embodiment of the electrode, the carbon is derived from cannabis. In one embodiment, the electrode is an anode, and wherein the anode is a partially ordered dense hard carbon anode having bulk potassium ion insertion. In another embodiment, the electrode is a cathode, wherein the cathode is a mesoporous activated carbon cathode having heteroatom-rich potassium ion adsorption and a high surface area.

Another embodiment is directed to an electrochemical energy storage device comprising: a mesoporous activated carbon anode comprising bulk ion insertion; and a mesoporous activated carbon cathode comprising bulk ion adsorption. In one embodiment, the ion is selected from sodium and potassium. In a particular embodiment, the ion is potassium. In one embodiment, the device further comprises an electrolyte, for example, a carbonate-based high voltage electrolyte.

A further embodiment is directed to an electrochemical energy storage device comprising: an electrode comprising a carbon derived from a natural precursor, the natural precursor selected from the group consisting of hemp, cannabis, mulberry branches, silkworm excrement, and combinations thereof.

These and other embodiments are described in more detail below.

### DETAILED DESCRIPTION OF THE INVENTION

Throughout the application, the following abbreviations and/or acronyms, as well as others, may be used: LIB—lithium ion battery; SIB and/or NIB—sodium ion battery; HIC—hybrid ion capacitor; EDLC—electrochemical double layer capacitor; MC and/or SIC—sodium ion capacitor; AC—activated carbon; HC—hard carbon; EDXS—energy dispersive X-ray spectroscopy; TEM—transmission electron microscope; SEM—scanning electron microscope; HAADF—high angle annular dark field; XRD—X-ray diffraction; BET—Brunauer-Emmett-Teller; DFT—density functional theory; XPS—X-ray photoelectron spectroscopy; CV—cyclic voltammetry; EIS—electrochemical impedance analysis; SEI—solid electrolyte interphase; CE—Coulombic efficiency.

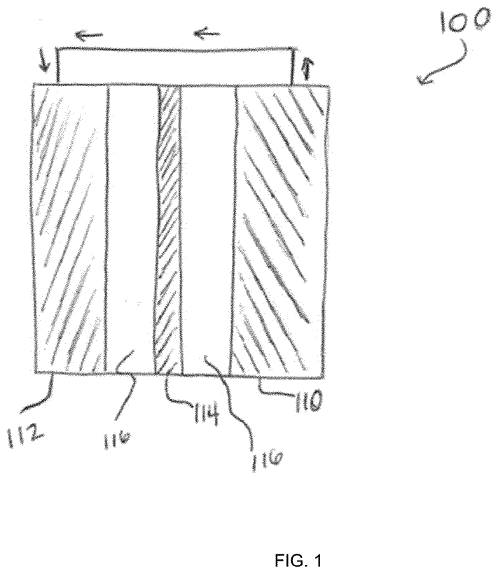

As shown in FIG. 1, a further embodiment of the invention is directed to an electrochemical energy storage device 100 that includes at least one electrode. As shown in FIG. 1, the device 100 includes an anode 110 and a cathode 112. In the particular embodiment shown in FIG. 1, the device 100 also includes a separator 114 disposed between the anode 110 and the cathode 112 and an electrolyte 116 in physical contact with both the anode 110 and the cathode 112. In one embodiment, the device 100 is a potassium-based electrochemical storage device, a hybrid ion capacitor, a potassium ion based capacitor. In one embodiment, the anode 110 includes a carbon material. In one embodiment the anode 110 includes a plurality of carbon-based spheres 10.

The electrode, i.e., the anode 110 and/or cathode 112, are described in detail herein. It is contemplated that the anode 110 and the cathode 112 may include other material(s) that are readily known and used in anodes and cathodes, e.g., hard carbon, graphite, other carbon-based material, additives, metallic-based materials, support structures, and the like.

The electrolyte 116 may be organic, ionic liquid, aqueous, or a combination. Standard battery and supercapacitor electrolytes are contemplated. Separator 114 may be in accordance with standard battery separators.

One embodiment of the device 100 is a device having asymmetric architecture. The device 100 having asymmetric architecture is based on, in one example, bulk potassium (K) ion insertion. In this embodiment, i.e., the device 100 having asymmetric architecture, the anode 110 is a partially ordered dense hard carbon (HC) anode having bulk potassium ion insertion and the cathode 112 is a mesoporous activated carbon (AC) cathode having heteroatom-rich potassium ion adsorption and a high surface area, which, in some embodiments, is rich in heteroatoms. Heteroatoms include any atom that is not carbon or hydrogen, and, for example include, but are not limited to O, N, P, Se, S, etc. The device 100 having asymmetric architecture may be referred to as an HC-AC device.

Carbon of the dense hard carbon anode is derived from a natural precursor. Natural precursors include, but are not limited to, plant and animal-based material. In particular examples, the natural precursor for the dense hard carbon anode is at least one of hemp, cannabis, mulberry branches and silkworm excrement. In a particular embodiment, the natural precursor is hemp. In another particular embodiment, the natural precursor is cannabis. Combinations of any of the foregoing examples of natural precursors are contemplated and acceptable for use.

In one embodiment of the asymmetric architecture of the device 100, carbon of the mesoporous activated carbon cathode is derived from a natural precursor. Natural precursors include, but are not limited to, plant and animal-based material. In particular examples, the natural precursor for the dense hard carbon anode is at least one of hemp, cannabis, mulberry branches and silkworm excrement. In a particular embodiment, the natural precursor is hemp. In another particular embodiment, the natural precursor is cannabis. Combinations of any of the foregoing examples of natural precursors are contemplated and acceptable for use.

Another embodiment is directed to a device 100, such as a hybrid ion capacitor (HIC), that is a double hybridized device. The double hybridized device employs a symmetric configuration of AC for the anode and AC for the cathode. A device 100 that is a symmetric configuration may be referred to as an AC-AC device, or, in a particular embodiment, as S-HIC (symmetric hybrid ion capacitor), S-HIC-K (S-HIC-potassium), S-HIC-Na (S-HIC-sodium).

A symmetrically configured device 100 includes a mesoporous activated carbon anode 110 comprising bulk ion insertion and a mesoporous activated carbon cathode 112 comprising bulk ion adsorption. In one embodiment, the ion is selected from sodium and potassium. In a particular embodiment, the ion is potassium.

In a particular embodiment, the symmetrically configured device 100 further includes an electrolyte, for example, a carbonate-based high voltage electrolyte.

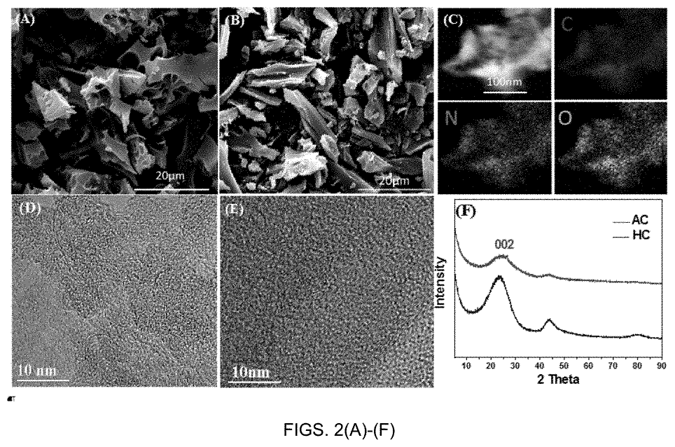

Hard carbons (HC) derived from natural precursors have a low degree of ordering in the material, i.e., are disordered or “amorphous”. Activated carbons (AC) derived from natural precursors also have a low degree of ordering in the material. This is shown in FIGS. 2(A)-(F). FIGS. 2(A) and (B) show scanning electron microscope (SEM) images of activated carbon “AC” and hard carbon “HC”. Both materials are a micron-scale 3D particulates, on par in their scale with conventional battery graphites, hard carbons and activated carbons. FIG. 2(C) displays high angle annular dark field (HAADF) transmission electron microscope (TEM) images and energy dispersive X-ray spectroscopy (EDXS) elemental maps of C, N and O elements in AC. The natural precursor is naturally rich in oxygen and nitrogen, which are retained following pyrolysis.

FIG. 2(D) presents a high resolution TEM (HRTEM) micrograph of AC demonstrating the low degree of ordering in the material. Per HRTEM, the HC specimen is similarly disordered, being shown in FIG. 2(E). FIG. 2(F) shows the X-ray diffraction (XRD) patterns of AC and HC. The patterns show two broad diffraction peaks that are indexed as (002) and (100) of the pseudographitic domains. The average graphene interlayer spacing can be calculated from the center position of (002) peaks.

As Table 1 shows, the mean graphene layer spacing (d002) for both HC and AC materials derived from natural precursors is significantly larger than that of graphite (0.40 and 0.39 vs. 0.3354 nm). While in-principle such dilated layer spacing may allow for ion intercalation into HC at the negative anode voltage, this is the case only for Na, but not for K. The average dimensions of the ordered graphene domains (Lₐ, L_{c}) are calculated by the well-known Scherrer equation, using the full-width-at-half-maximum values of (002) and (100) peaks, respectively. Per Table 1, the average domain thickness L_{c} is on par for both carbons, being 1.50 nm for AC and 1.68 for HC. The average domain width Lₐ for HC is twice as wide as for AC, being 8.04 nm vs. 4.04 nm.

TABLE 1
Hard carbon HC and activated carbon AC
structural and textural properties.

| | | | | | Textural properties | | | |
|---|---|---|---|---|---|---|---|---|
| | Carbon structure | | | | S_{BET}^{b} | V [symbol] | Micro- | Meso- |
| | d₀₀₂ | Lₐ | L_{c} | | (m² | (cm³ | pores | pores |
| Sample | (nm) | (nm) | (nm) | [symbol] | g⁻¹) | g⁻¹) | vol. % | vol. % |
| AC SE | 0.40 | 4.04 | 1.50 | 0.71 | 1602 | 1.04 | 81.9 | 18.1 |
| HC MS | 0.39 | 8.04 | 1.68 | 0.97 | 32 | 0.05 | 52.2 | 47.8 |

^{a}I_{D} and I_{O} are the integrated intensities of D- and G-band.
^{b}Surface area was calculated with Brunauer-Emmett-Teller (BET) method.
^{c}The total pore volume was determined at a relative pressure of 0.98. [symbol]
indicates data missing or illegible when filed

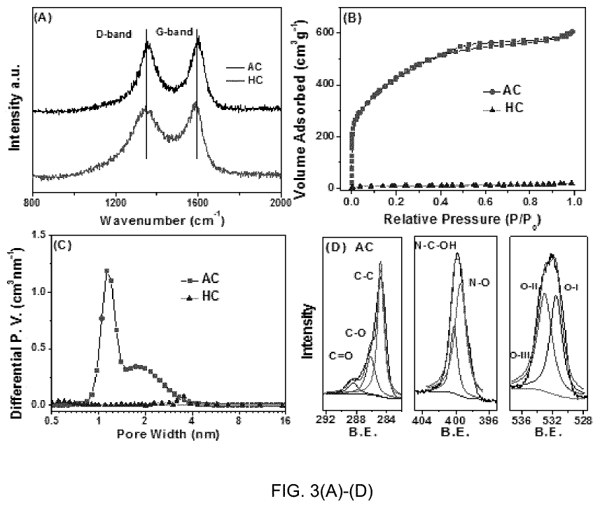

Raman spectroscopy data for the HC and AC derived from natural precursors are shown in FIG. 3A. Both AC and HC exhibit broad disorder-induced D-bands (≈1340 cm⁻¹) and in-plane vibration G-bands (≈1580 cm⁻¹). The values of the integral intensity of D- and G-bands may be employed to index the degree of defectiveness in a carbon.

Table 1 shows the integrated intensity ratio of the G and D peaks for both materials. The IG/ID ratio for HC is 0.97, while it is 0.71 for AC. In HC, an integrated G to D band ratio of equal or greater than 1 is known to promote reversible Na intercalation at anode voltages. As demonstrated by the inventors, the same HC material with K shows minimal electrochemical evidence of reversible intercalation even at relatively slow charging rates.

FIG. 3(B) shows the nitrogen adsorption-desorption isotherms of AC and HC, while FIG. 3(C) shows their pore size distributions (obtained by density functional theory (DFT)). Table 1 also provides the porosity characteristics of both materials. The AC specimens show Type I/IV isotherms with a BET surface are of 1602 m²/g, 82% micropores and 18% mesopores. The total pore volume of AC specimens was 1 cm³/g.

The pyrolized but not activated HC possessed a relatively low surface area of 32 m²/g. FIG. 3(D) displays the XPS fitted high-resolution spectra and the survey spectra, respectively. The C1s, N1s and O1s of the SEG is shown in FIG. 3(D).

Table 2 lists the surface and bulk element composition of the prepared carbons, as well as the oxygen functionalities obtained by XPS. The nitrogen content is 11.66 wt % for AC, which is on the high end of reported K anode materials. The N1s peak mainly includes pyridinic N and N-oxides (399.5-402 eV). The C1s peak is dominated by a C-C bond at 284.6 eV and the O1s peak is at 531-533 eV. The oxygen content of AC as 17.87%, while that of HC was 8.24%. The difference in the heteroatom content may be rationalized by the N and O content in the precursor. The N moieties should be highly chemically active and are likely to introduce additional defects into the graphene planes. Nitrogen functionalities and associated defects will enhance AC's capacity to reversibly bind with charge carriers such as Li, Na and K.

TABLE 2
Bulk and surface chemistry of AC and HC.

| | | | | | | | Functionality | | |
|---|---|---|---|---|---|---|---|---|---|
| | XPS (wt %) | | | EDX (wt %) | | | (% of O [symbol] s) | | |
| Sample | C | N | O | C | N | O | O-I | O-II | O-III |
| AC | 71.43 | 11.66 | 16.91 | 70.22 | 11.91 | 17.37 | 57.62 | 42.27 | 0.11 |
| HC | 89.08 | 1.68 | 9.24 | 90.17 | 1.59 | 8.24 | 40.26 | 58.35 | 1.39 |

[symbol]

indicates data missing or illegible when filed

It is noted that excrement of most living things is naturally rich in nitrogen and oxygen, whereas wood is not. Other potential impurities that may be present in plant-based precursors (e.g. P, K, Mg, Ca) were below the detection limits of XPS analysis, being both volatilized during synthesis and further removed by the post-synthesis HCl wash.

One embodiment of the invention is directed to an electrochemical energy storage device that includes an electrode comprising a carbon derived from a natural precursor as described above.

These and other embodiments are described in more detail in the following examples, wherein certain aspects of the invention are exemplified. The Examples are not mean to limit the invention to particular characteristics or attributes, but rather, to illustrate some embodiments of the invention.

### Examples

### I. Anode Performance Comparison

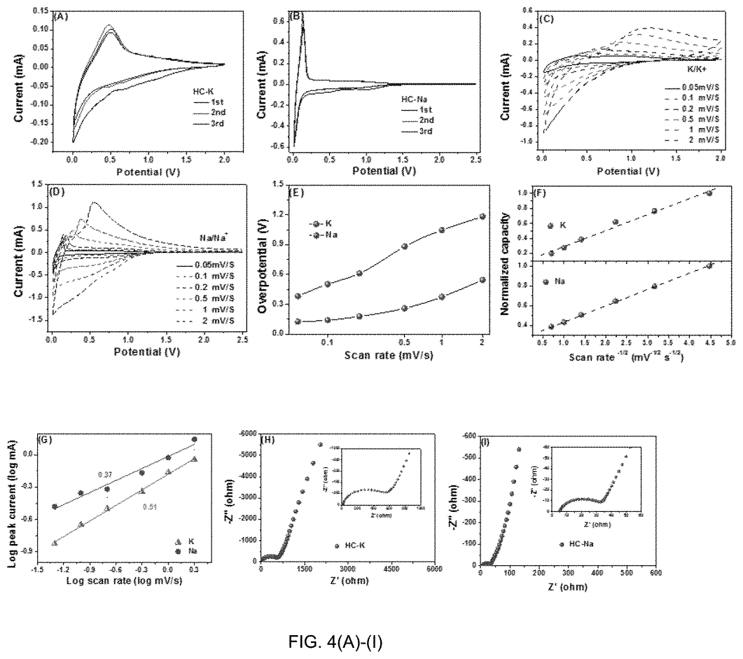

FIG. 4 (A)-(I) contrast the electrochemical performance results for HC tested in a half-cell configuration vs. K/K+ and Na/Na+. FIGS. 4(A) and (B) compare the CV curves for K/K+ and Na/Na⁺ for cycles 1-3, tested at 0.1 mV s⁻¹. During potassiation there is a broad cathodic peak starting at near 1 V and continuing to the terminal 0.01 V. The anodic (depotassiation) peak being is centered at 0.5 V and shows a large hysteresis as compared to the cathodic peak. This hysteresis is markedly larger than it is for the sodiation-desodiation reactions, that CV being shown in FIG. 4(B). Being partially ordered and with a dilated interlayer spacing, HC is able to reversibly intercalate Na ions with majority of the reversible capacity being below 0.25 V. The desodiation possesses a low hysteresis, the difference between the peak charge and discharge current in the CV being below 0.15 V at the slower scan rates, per FIG. 4(E). Importantly, the low voltage plateau demonstrated in the CVs and the galvanostatic data for HC with Na is distinctly missing with the same materials tested against K.

With Na, the dominant charge storage mechanism is below approximately 0.25 V vs. Na/Na⁺. For instance, through detailed X-ray diffraction it has been demonstrated that the reversible Na intercalation into partially ordered hard carbons is the key source of capacity below 0.25 V vs. Na/Na⁺. It was shown that with increasing graphene layer ordering and domain size, due to a higher heat treatment temperature, the low voltage plateau capacity increased while the higher voltage capacity either decreased or remained constant.

Raman Spectroscopy provides further evidence of Na staging reactions in these partially ordered albeit non-graphitic domains of graphene. K does not undergo the same intercalation process into the hard carbon as does Na.

The presence of O in the HC material may impact reversible adsorption of both Na and K ions at less negative anode voltages. Sodium reversibly binds to the heteroatom moieties, to the actual dopants, or to the defects in the structure that accompany dopant introduction. It is expected that O and N would have a similar influence on K storage. The most ion active oxygen moieties should be the quinone type groups (C═O/O-C═O, O-I type) due to the unsaturated carbon-oxygen double bond. The HC materials possess significant O-I content, per Table 2.

The inventors posit that lower overall capacity of K vs. Na is due to diffusional limitations of the former, which inhibits full potassiation even at relatively slow charging rates. Per FIG. 4(C) it may be observed that the potassiation overpotential at every scan rate tested is consistently higher than the sodiation overpotential. This difference increases with scan rate, being nearly 0.7 V at 2 mV/sec. The inventors posit that this is also a diffusivity effect, where the inherently sluggish kinetics of K insertion-extraction in HC leads to major IR loss on both charge and discharge.

To further understand the electrochemical kinetics of HC with K vs. Na, the inventors plotted the current response at scan rates of 0.05-2 mV/s. Such multi-rate CV scan tests are suited for examining charge/discharge kinetics to understand regions of diffusional vs. reaction control. These results are shown in FIGS. 4(C) and (D), comparing the K and Na systems in both cases. A well-established method at looking at the onset of diffusional limitations is a mathematical “b-value” analysis. This straightforward method tracks the transition in the time dependence of the peak current, i.e. the peak reaction rate. The current change with the scan rate may be expressed as i=av^{b}, where a, b are adjustable constants. Having a b-value of 0.5 signals a diffusion-limited process. Conversely, a b-value of 1 is for any activation polarization reaction. This may be for any reaction limited process, including but not limited to surface capacitance and pseudocapacitance. For example, nucleation-controlled growth of a precipitate phase is a solid-state processes that follows linear time kinetics, but is not capacitive in nature. For micron-scale low surface area materials such as HC, diffusional limitations are in the solid-state rather than through pore filled electrolyte.

The relation between the normalization capacity during the CV tests and the v^{-1/2} values is one way to understand at what rates reaction control transitions to diffusion control. These results are shown in FIG. 4(F). The normalized capacities are calculated according to C=iΔt/mΔE, where C is capacity, at and LE are the time and voltage change around the peak, and m is the mass of electrodes. Per FIG. 4(F), at all scan rates tested both potassiation and sodiation reactions are diffusion controlled. A plot of the normalized capacity versus the inverse square root of scan rate remains linear. There is no low scan rate where the processes transitions to reaction control instead. FIG. 4(G) confirms this conclusion, where the b-value analysis yields a square root time dependence at all scans. Results in FIG. 3(G) are shown for the anodic scans only.

FIGS. 4(H)-(I) compare the electrochemical impedance analysis (EIS) of the half-cells with K/K+ and with Na/Na⁺. FIG. 4(H)-(I) present the high frequency portion Nyquist plots of HC with K and Na, respectively. Analysis is shown after 3 cycles, tested at OCP, in the fully depotassiated/desodiated state. The Nyquist plots contain a semicircle located at the high frequency region, which correlates to overlapped solid electrolyte interphase (SEI) impedance RsEI and charge transfer impedance RCT. Although in principle the higher frequency RsEI should be distinguishable from the lower frequency RCT, in practice they overlap for both Na and K. It may be observed from the plots, there is more than an order of magnitude difference between RsEI for K (585 Ohms) versus for RsEI Na (23.4 Ohms). The result indicates that the SEI structure of HC tested with K is much more resistive than with Na.

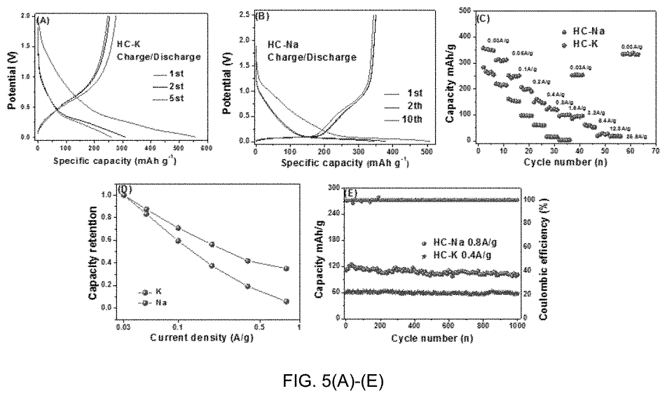

FIG. 5 compares the galvanostatic performance of HC in K vs. Na half-cells. These results are consistent with the CV data presented in the earlier set of figures. FIGS. 5(A) and (B) show the actual galvanostatic charge-discharge curves at 30 mA g⁻¹, for cycles 1, 2 and 5. FIGS. 5(C)-(D) compare the capacities at various current densities, with 4C showing the absolute capacity and 5(D) showing the relative capacity retention. FIG. 5(E) compares the cycling stability of HC with K and Na. With K, the half-cell displays a high-voltage sloping region with a minimal low voltage plateau. This is distinct from the Na case, where there is nearly 200 mAh/g of reversible capacity below 0.1 V vs. Na/Na⁺. This is equivalent to more than 57% of the total capacity being in the plateau region, i.e. attributed to reversible Na intercalation between graphene planes. For K, the low voltage sloping region of the capacity curve holds about 50 mAh/g of charge, which is only 17% of its total capacity. The overall reversible capacity with K is lower as well, being 270 mAh/g vs. 349 mAh/g. The cycle 1 Coulombic efficiency (CE) for K is also lower, being at 49% versus 69% for Na. At cycle 1 there is more irreversible K ion trapping, especially at the higher voltages. Reversible K ion storage also occurs at higher voltages than with Na. Based on the shape of the galvanostatic data one can reasonably argue that reversible K ion binding at defect sites dominates capacity.

Per FIGS. 5(C)-(D), with increasing current density, the reversible capacity of the K cell decreases faster than of the Na cell. For instance, at 1600 mA/g, the K cell has negligible capacity, whereas the Na cell retains 100 mAh/g. The inventors posit that the poorer rate capability with K is due to solid-state diffusional limitations and the influence of a higher combined SEI and interfacial impedance. Diffusion limitations, be it through the bulk carbon or through the SEI, will become most severe at high charging rates. Both the K and the Na cells exhibit a relatively stable cycling performance, as shown in FIG. 5€. After 1000 cycles, the capacity retention of with K is 85% at 400 mA/g. The capacity retention with Na is 80% at 800 mA/g. The inventors consider these cycling retention values to be on par. However, the origin of the capacity decay may be different with Na vs. K. For Na intercalating into HC, the associated volume changes lead to capacity decay due to gradual cycling-induced exfoliation. Since K does not significantly insert into HC, the capacity decay may be instead driven by excessive SEI formation, agreeing with the EIS results.

### II. Device and Cathode Performance Comparison

Half-cell results highlight the performance versus K, Na or Li metal counter electrode. In a half-cell, the voltage swing of the working electrode is set. Hence the thermodynamic conditions of the working electrode and of the electrolyte are well-defined at every current. But in a full cell hybrid device, the electrolyte may not see any metal interface at all, unless there is unintended plating on the anode during cycling. In a full cell, the relative voltage swing of each electrode, as a fraction of the total voltage, is determined by the anode-to-cathode capacity ratio. In a half-cell the HC electrode will develop a solid electrolyte interphase (SEI) below approximately 1 V vs. K/K+, Na/Na⁺ or Li/Li⁺. Irreversible capacity loss associated with SEI formation may be quite substantial with initial CE values being as low as 30%. The metal counter electrode itself is highly catalytic toward SEI formation, showing up the EIS spectra, etc. Conversely, in AC-AC and HC-AC full cells, there should be no metal K/Na in the device (unless plating occurs). The active ions originate from the dissociated salt. Therefore, the two sets of data for a given material are not directly transposable. For example, electrolyte decomposition on the anode in a full cell cannot be directly predicted from half-cell performance. Instead, SEI formation it must be obtained directly from full cell results.

The inventors investigated two types of architectures for both K and Na devices. The first is an approach based on symmetric AC-AC cells. It is noted that, strictly speaking the configuration is not truly “symmetric” since the mass ratio between the anode and the cathode is 1:2, so as to achieve capacity balancing. The core difference for hybrid device is that when employing battery electrolytes, there are other charge storage mechanisms in addition to EDLC. A symmetrical-like NIC configuration is known to give promising energy and cyclability values as long as the device voltage window is kept narrow enough to prevent excessive SEI formation on the anode. A conventional acetonitrile solvent used for EDLC devices usually has a 2.7 maximum voltage window. Carbonate electrolytes used for NICs and KICs should thermodynamically stable at 3 V, especially if there are no catalytic metal surfaces. Therefore, there is an inherent advantage since device energy scales with the voltage window squared.

The inventors observed that with both K and Na, the stable voltage window for a symmetric AC-AC device was 3 V. At higher voltages, capacity decay was rapid. This is likely due to both SEI formation on the anode and cathode electrolyte interface (CEI) formation on the cathode. However, with both K and Na the 3V AC-AC devices were able to cycle relatively well. A device voltage of 0V (fully discharged) is not synonymous with a half-cell voltage of 0V vs. Na/Na⁺ or K/K+. In the half-cell the electrolyte is thermodynamically unstable while being in direct contact with a catalytic metal surface.

In an AC-AC hybrid device configuration, despite the electrodes being the same material, the charge storage mechanisms will be fundamentally distinct. As discussed, both K+ and Na⁺ are able to insert into the bulk of most anode carbons. This is fundamentally different from an ideal EDLC ultracapacitor, where there is no bulk cation insertion. It is also the origin of the non-ideality of the hybrid device charge-discharge curves, since pure physical adsorption would yield perfectly triangular profiles. Conversely, the ClO₄⁻ and PF₆⁻ counterions should only physically adsorb onto the AC cathode surfaces. Bulk ClO₄ and PF₆⁻ insertion has not been reported. Therefore, for KICs and NICs, reversible adsorption of PF₆⁻ and ClO₄⁻ counterions on the cathode will also contribute to the reversible capacity. Since Na⁺ and K⁺ are naturally adsorbed on carbon surfaces at open circuit, another source of capacity in the cathodes should be their repulsion during positive polarization.

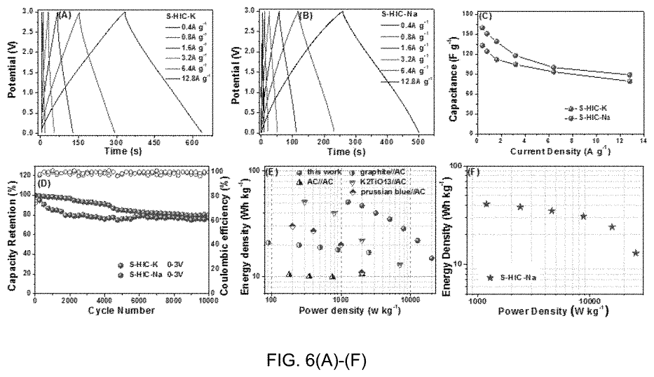

The electrochemical performance results of AC-AC potassium and sodium based HICs is shown in FIG. 6(A)-(F). FIGS. 6(A)-(B) highlight the galvanostastic results for symmetric HIC based on K (S-HIC-K) and symmetric HIC based on Na (S-HIC-Na). It can be seen that the shape of charge-discharge curves deviates from the ideal triangular due to the non-EDLC storage mechanisms described earlier. Tests were performed at the same range of current densities for S-HIC-K and S-HIC-Na, 0.4 A/g to 12.8 A/g. Per FIG. 6(C), the performance of S-HIC-K is on-par with S-HIC-Na in terms of energy and rate capability. The cycle 1 CE of the S-HIC-K and S-HIC-Na devices is also similar, being at 74% and 76%, respectively. The Nyquist EIS plot indicates that the S-HIC-K shows a somewhat lower RCT versus S-HIC-Na, being 2.9 Ohm vs. 5.2 Ohms. Per FIG. 6(D), the shorter-term cyclability of S-HIC-K is somewhat superior to S-HIC-Na, although after 10000 cycles the two systems also become on-par.

FIG. 6(E) compares the Ragone Chart characteristics of the S-HIC-K devices versus recent asymmetric K ion capacitor and K based supercapacitor. FIG. 6(E) illustrates that K-based cells which employ bulk insertion anodes all appear to be power-limited. Comparing the Ragone Chart characteristics of S-HIC-K in FIG. 5(E) with the identically tested S-HIC-Na in FIG. 5(F), it is evident that the K device delivers analogous specific energies at all specific powers tested. For instance, AC-AC-K achieved 51 Wh/kg at 1260 W/kg, 35 Wh/kg at 5020 W/kg, and 15 Wh/kg at 20110 W/kg. The AC-AC-Na achieved 41 Wh/kg at 1200 W/kg, 35 Wh/kg at 4576 W/kg, and 13 Wh/kg at 25600 W/kg. The inventors consider these values similar, indicating the kinetics of Na and K diffusion in electrolyte filled pores, as well as the reversible adsorption on carbon surfaces, are on par as well.

The K and Na devices were also tested in an asymmetric hybrid ion capacitor configuration, namely employing the low surface area bulk HC anode opposing the high surface area AC. These devices are labeled A-HIC-K and A-HIC-Na, i.e. asymmetric hybrid ion capacitors. We employed a voltage window commonly employed for hybrid Na and Li devices (1.5-4.2V). This range maximized the operating voltage window without decomposing the electrolyte. However, without the presence of catalytic Na/K bulk metal, a voltage window of 0-2.7 V would have achieved the same effect. Upon positive polarization the AC electrode will reversibly adsorb ClO₄⁻ and reversibly release Na⁺. Capacity in AC is achieved both by EDLC of ClO₄⁻, and through an interaction of Na⁺ with surface defects and oxygen functionalities. One could argue a similar process with AC employed for A-HIC-K: Upon polarization K⁺ is reversibly released and PF₆⁻ is reversibly adsorbed. Capacity is achieved both by EDLC of PF₆⁻ and through interaction of K⁺ with surface defects and oxygen functionalities.

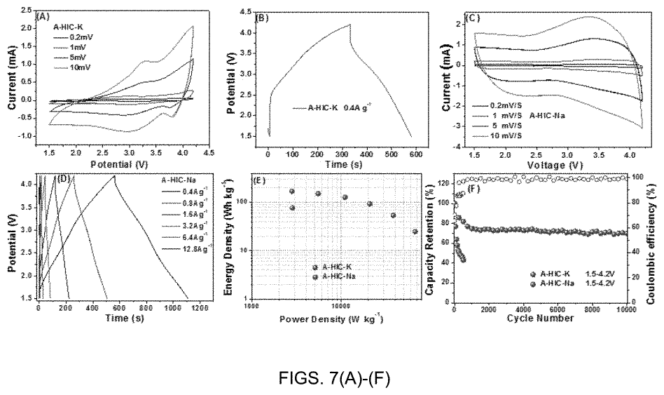

The CV curves for A-HIC-K shown in FIG. 7(A) demonstrate highly resistive behavior as indicated by their truncated shape, and the nearly 45° slope in the anodic currents. As is shown in FIG. 7(B), for A-HIC-K there is a major IR drop even at a low current density of 0.4 A/g. Because of such severely limited rate capability of A-HIC-K, it was not analyzed at higher current densities. We attribute such poor rate capability to the kinetic sluggishness of the HC anode, as documented with K/K⁺ half-cell results. The CV and galvanostatic performance of the A-HIC-Na device is shown in FIGS. 7(C)-(D). As shown in FIG. 7(C), the CV curves of A-HIC-Na device display a box-like pseudocapacitive shape overlaid with redox humps due to the anode. At higher rates, the CVs and the galvanstatic profiles become more distorted, although the IR drop remains relatively low even at 12.8 A/g. FIG. 7(E) compares the Ragone plot of A-HIC-Na with the single data point obtained for A-HIC-Na. The specific energy and specific power values are based on the total mass of the active and inactive materials in both electrodes. The A-HIC-Na shows fairly good performance, superior to the data point for the A-HIC-K device. The A-HIC-K cell yields 77 Wh/kg at 2830 W/kg. The A-HIC-Na cell shows a flat energy-power profile with 170 Wh/kg at 2800 W/kg, 152 Wh/kg at 5500 W/kg, 127 Wh/kg at 11100 W/kg, 93 Wh/kg at 20880 W/kg, 54 Wh/kg at 38400 W/kg, and 25 Wh/kg at 67200 W/kg. FIG. 7(F) compares cycling stability of the A-HIC-K and A-HIC-Na devices. The A-HIC-Na cell survives 10,000 cycles with 70% capacity retention. Its cycle 1 CE is 74%, cycle 2 CE is 83%, cycle 10 CE is 95%, cycle 50 CE is 98%, and close to 100% CE (within measurement accuracy) afterward. The A-HIC-K cell starts on cycle 1 CE at 65%, cycle 2 CE at 77%, cycle 10 CE is 88%, cycle 50 CE is 84%, and around 87% afterward. This indicates that with K, there is more irreversible ion trapping at every cycle than with Na.

### III. Experimental

Hemp, cannabis, dried silk worm excrement, or mulberry bush material was employed as a precursor for the high surface area N-rich carbon, termed “AC”. The material was pre-carbonized at 400° C. and allowed to cool. The partially carbonized material was then mixed with an aqueous solution of KOH (Adamas-beta) in a mass ratio of 3:1, followed by activation at 800° C. for 100 min under N2 flowing at 100 mL min⁻¹ in a horizontal quartz tube furnace. The slurry was then dried at 70° C. to remove the water. The precursor-KOH mixture as activated in under a N2 flow rate of 100 mL min⁻¹ in a horizontal alumina tube furnace at 800° C. The heating rate to temperature was 5° C./min, followed by 100 minute hold, followed by natural cooling. The obtained product was washed with 1.0 M HCl to remove the inorganic impurities, and then washed with deionized water until the sample became neutral. The product was then dried for 10 h at 70° C. The hard carbon termed “HC” was derived from hemp, cannabis, dried silk worm excrement, or mulberry bush material. The precursor was carbonized at 1200° C. in flowing Ar, washed with dilute hydrochloric acid and deionized water and dried.

Scanning electron microscopy (SEM, JSM-65900LV, JSM-7500F, JEOL) and transmission electron microscopy (TEM, JEM-2100F, JEOL) were employed to analyze the morphology and structure of the specimens. Elemental analysis (Elementar, vario ELITE) and X-ray photoelectron spectroscopy (XPS, UIVAC-PHI PHI 5000 VersaProbe) were employed to provide information regarding bulk chemistry and surface functional groups. The Raman spectra were collected with 532 nm excitation and 20× objective on a Thermo Nicolet Almega system. The laser power was <2 mW. X-ray diffraction (XRD) analyses of the prepared ACs were carried out using a Bruker-D8 Advance X-ray Diffractometer at a scanning speed of 5° min⁻¹. The textural properties were determined at 77K using nitrogen using a JWGB SCI. & TECH JW-BK100C sorptometer over a relative pressure range of 10⁻⁶ to 0.995 atm. The surface area was calculated using the Brunauer-Emmett-Teller (BET) equation based on adsorption data in the partial pressure (P/P₀) ranging from 0.02 to 0.25. The total pore volume was determined from the amount of nitrogen adsorbed at a relative pressure of 0.98. Pore size distributions were calculated by using the Density Functional Theory (DFT) Plus Software, which is based on calculated adsorption isotherms for pores of different sizes. Samples were degassed at 300° C. for 600 min prior to the measurements.

Electrodes for symmetrical AC-AC based devices were prepared by mixing 80 wt % AC, 10 wt % Super P (conductive carbon), and 10 wt % PVDF binder. This mixture was coated onto an aluminum foil and dried at 70° C. for 10 hrs. In a vacuum oven. The mass loading of ACs on each electrode was close to 4 mg/cm², which may be considered relatively high for a laboratory study, especially with the slower diffusing K ions. Asymmetric HC-AC devices were assembled with the HC as the negative electrode “anode”, and AC as the positive electrode “cathode”. The mass loading ratio between the anode and the cathode was ˜1:2. Since the aim was to provide direct general comparisons rather than optimize system performance, no electrolyte additives were employed. Electrochemical testing was done using laboratory-grade CR2032 stainless steel coin cells at room temperature. LAND (CT2001A) workstations were employed for galvanostatic analysis, CHI760B workstations were employed for cyclic voltammetry, and CHI760B workstations were employed for electrochemical impedance analysis (EIS). EIS analysis was performed in the frequency range of 100 kHz to 10 mHz at the open circuit voltage with an alternate current amplitude of 5 mV.

Prior to NIC or KIC device assembly, the anodes were galvanostatically cycled as half-cells vs. Na/Na⁺ or K/K⁺, being performed three times between 2.5-0.01 V. In the 0.01 V terminally sodiated or potassiated state, the half-cells were then disassembled, and the anodes incorporated into full cell NICs and KICs. Apart from the ions stored in the anode and dissolved in the electrolyte, no other Na⁺ or K⁺ source was present. The open circuit voltage of the as-assembled and equilibrated NICs and KICs, was about 2.0 V and 2.2 V, respectively. The K electrolyte was 0.8 M KPF₆ in 1:1 by volume ethylene carbonate/diethyl carbonate (EC/DEC). The Na electrolyte was 1 M NaClO₄ in 1:1 EC/DEC. These salts and their concentrations agree well with what is commonly employed for Na and K ion battery electrolytes.

The gravimetric energy (E_{g}) and gravimetric power (P_{g}) of devices is calculated according to the following equations:

P_{g}=I×ΔV/m (1)

E_{g}=P×t/3600 (2)

ΔV=(Vₘₐₓ+Vₘᵢₙ)/2 (3)

where I is the discharge current (A), m is the mass of the total active and inactive materials on both electrodes (kg), t is the discharge time (h), Vₘₐₓ is the potential at the beginning of discharge after the IR drop, and Vₘᵢₙ is the potential at the end of discharge. The device energy and power calculations are presented based on the weight of all materials in the two electrodes, including the inactive carbon black and binder.

As will be apparent to those skilled in the art, various modifications, adaptations and variations of the foregoing specific disclosure can be made without departing from the scope of the invention claimed herein. The various features and elements of the invention described herein may be combined in a manner different than the specific examples described or claimed herein without departing from the scope of the invention. In other words, any element or feature may be combined with any other element or feature in different embodiments, unless there is an obvious or inherent incompatibility between the two, or it is specifically excluded.

References in the specification to “one embodiment,” “an embodiment,” etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such aspect, feature, structure, or characteristic with other embodiments, whether or not explicitly described.

The singular forms “a,” “an,” and “the” include plural reference unless the context clearly dictates otherwise. Thus, for example, a reference to “a plant” includes a plurality of such plants. It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The term “and/or” means any one of the items, any combination of the items, or all of the items with which this term is associated. The phrase “one or more” is readily understood by one of skill in the art, particularly when read in context of its usage.

Each numerical or measured value in this specification is modified by the term “about”. The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by the skilled artisan, all numbers, including those expressing quantities of reagents or ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range (e.g., weight percents or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, as used in an explicit negative limitation.

What is claimed is:

1. A potassium-based electrochemical storage device comprising:
a partially ordered dense hard carbon anode having bulk potassium ion insertion; and
a mesoporous activated carbon cathode having heteroatom-rich potassium ion adsorption and a high surface area.

2. The potassium-based electrochemical storage device according to claim 1, wherein carbon of the dense hard carbon anode is derived from a natural precursor.

3. The potassium-based electrochemical storage device according to claim 2, wherein the natural precursor is at least one of hemp, cannabis, mulberry branches and silkworm excrement.

4. The potassium-based electrochemical storage device according to claim 1, wherein carbon of the mesoporous activated carbon cathode is derived from a natural precursor.

5. The potassium-based electrochemical storage device according to claim 4, wherein the natural precursor is at least one of hemp, cannabis, mulberry branches and silkworm excrement.

6. An electrode for an electrochemical energy storage device, the electrode comprising:
a carbon derived from a natural precursor, the natural precursor selected from the group consisting of hemp, cannabis, mulberry branches, silkworm excrement, and combinations thereof.

7. The electrode according to claim 6, wherein the carbon is derived from hemp.

8. The electrode according to claim 6, wherein the carbon is derived from cannabis.

9. The electrode according to claim 6, wherein the electrode is an anode.

10. The electrode according to claim 9, wherein the anode is a partially ordered dense hard carbon anode having bulk potassium ion insertion.

11. The electrode according to claim 6, wherein the electrode is a cathode.

12. The electrode according to claim 11, wherein the cathode is a mesoporous activated carbon cathode having heteroatom-rich potassium ion adsorption and a high surface area.

13. The electrode according to claim 6, wherein the electrochemical energy storage device is a potassium ion capacitor.

14. A electrochemical energy storage device comprising:
a mesoporous activated carbon anode comprising bulk ion insertion; and
a mesoporous activated carbon cathode comprising bulk ion adsorption.

15. The electrochemical energy storage device according to claim 14, wherein the ion is selected from sodium and potassium.

16. The electrochemical energy storage device according to claim 14, further comprising an electrolyte.

17. The electrochemical energy storage device according to claim 16, wherein the electrolyte is a carbonate-based high voltage electrolyte.

18. An electrochemical energy storage device comprising:
an electrode comprising a carbon derived from a natural precursor, the natural precursor selected from the group consisting of hemp, cannabis, mulberry branches, silkworm excrement, and combinations thereof.
